(19) United States
(12) Patent Application Publication
(10) Pub. No.: US 2022/0185097 A1
(43) Pub. Date: Jun. 16, 2022

(54) SHUTTER DEVICE FOR VEHICLE

(71) Applicants: DENSO CORPORATION, Kariya-city (JP); Gomunolnaki Co., Ltd., Nagoya (JP)

(72) Inventors: Akihiro MAEDA, Kariya-city (JP); Yukio SHIDARA, Kariya-city (JP); Takuya HARA, Kariya-city (JP); Masafumi YAMAGUCHI, Kariya-city (JP); Tokuhisa TAKEUCHI, Kariya-city (JP); Daiken IWAKAWA, Nagoya-city (JP); Eisaku TAKEUCHI, Nagoya-city (JP); Kouichi HIGUCHI, Nagoya-city (JP)

(21) Appl. No.: 17/683,105

(22) Filed: Feb. 28, 2022

Related U.S. Application Data
(63) Continuation of application No. PCT/JP2020/035118, filed on Sep. 16, 2020.

(30) Foreign Application Priority Data
Sep. 27, 2019 (JP) 2019-177146

(51) Int. Cl. B60K 11/04; B60K 11/08; B60R 19/52

(52) U.S. Cl. CPC B60K 11/04; B60R 19/52; B60K 11/085

(57) ABSTRACT

A shutter device for a vehicle includes a frame, a plurality of blades and a cushion member. The frame is placed between two heat exchangers. The blades are configured to open and close an inner space of the frame through rotation of the blades. The cushion member is configured to project from the frame toward an adjacent one of the one or more heat exchangers which is placed adjacent to the frame. A direction, in which the cushion member projects from the frame, is defined as a predetermined direction. The cushion member has an elastic property that a repulsive force of the cushion member exponentially changes in response to a change in an amount of shrinkage deformation of the cushion member in the predetermined direction.

### CROSS REFERENCE TO RELATED APPLICATIONS

This application is a continuation application of International Patent Application No. PCT/JP2020/035118 filed on Sep. 16, 2020, which designated the U.S. and claims the benefit of priority from Japanese Patent Application No. 2019-177146 filed on Sep. 27, 2019. The entire disclosures of all of the above applications are incorporated herein by reference.

### TECHNICAL FIELD

The present disclosure relates to a shutter device for a vehicle.

### BACKGROUND

In vehicles, the air, which is introduced from a grill opening into an engine room, is used to release heat from a radiator, through which engine coolant is circulated, and is also used to release heat from a condenser of a vehicle air conditioning apparatus. One such vehicle includes a shutter device that can temporarily block a flow of the air from the grill opening into the engine room.

### SUMMARY

This section provides a general summary of the disclosure, and is not a comprehensive disclosure of its full scope or all of its features.

According to the present disclosure, there is provided a shutter device for a vehicle including a frame, a plurality of blades and a cushion member. The plurality of blades are located in an inner space of the frame and are rotatably supported by the frame. The plurality of blades are configured to open and close the inner space of the frame through rotation of the plurality of blades. The cushion member is configured to project from the frame toward an adjacent heat exchanger which is placed adjacent to the frame. A direction, in which the cushion member projects from the frame, is defined as a predetermined direction. The cushion member has an elastic property that a repulsive force of the cushion member exponentially changes in response to a change in an amount of shrinkage deformation of the cushion member in the predetermined direction.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram schematically showing a structure of a vehicle.

FIG. 2 is a perspective view showing a structure of a shutter device of a first embodiment.

FIG. 3 is an enlarged view showing a connection between a link member and a shaft in the shutter device of the first embodiment.

FIG. 4 is a diagram schematically showing a frontal structure of a frame of the first embodiment.

FIG. 5 is a perspective view showing a structure of the frame and an attachment member of the first embodiment.

FIG. 6 is a perspective view showing a structure of a cushion member of the first embodiment.

FIG. 7 is a cross-sectional view showing a structure of the frame to which the attachment member of the first embodiment is installed.

FIG. 8 is a diagram schematically showing a positional relationship among the shutter device, a radiator and a condenser of the first embodiment.

FIG. 9 is a graph showing a relationship between a shrinkage deformation amount and a repulsive force of the cushion member of the first embodiment.

FIG. 10 is a perspective view showing a structure of an attachment member according to a first modification of the first embodiment.

FIG. 11 is a perspective view showing a structure of another attachment member according to the first modification of the first embodiment.

FIG. 12 is a perspective view showing a structure of an attachment member according to a second modification of the first embodiment.

FIG. 13 is a perspective view showing a structure of an attachment member according to a third modification of the first embodiment.

FIG. 14 is a perspective view showing a structure of an attachment member according to a fourth modification of the first embodiment.

FIG. 15 is a perspective view showing a structure of a frame and an attachment member of a second embodiment.

FIG. 16 is a cross-sectional view showing a structure of the frame to which the attachment member of the second embodiment is installed.

FIG. 17 is a perspective view showing a structure of a frame and a cushion member of another embodiment.

FIG. 18 is a perspective view showing a structure of a cushion member of another embodiment.

FIG. 19 is a perspective view showing a structure of a cushion member of another embodiment.

FIG. 20 is a perspective view showing a structure of a cushion member of another embodiment.

FIG. 21 is a perspective view showing a structure of a cushion member of another embodiment.

FIG. 22 is a perspective view showing a structure of a cushion member of another embodiment.

### DETAILED DESCRIPTION

In vehicles, the air, which is introduced from a grill opening into an engine room, is used to release heat from a radiator, through which engine coolant is circulated, and is also used to release heat from a condenser of a vehicle air conditioning apparatus. One such vehicle includes a shutter device that can temporarily block a flow of the air from the grill opening into the engine room.

One such shutter device includes a frame, which is shaped in a rectangular form, and a plurality of blades, which are placed at an inside of the frame. The blades are arranged one after another in a gravitational direction at the inside of the frame. Each of the blades extends in a horizontal direction and has two shaft parts respectively located at two end parts of the blade which are opposed to each other in the horizontal direction. The shaft parts of each blade are slidably inserted into corresponding insertion holes, respectively, of the frame. Each insertion hole extends through the frame from an inner wall surface to an outer wall surface of the frame. Each blade is rotatably supported by the frame through bearing structures each of which is formed by the corresponding shaft part of the blade and the corresponding insertion hole of the frame. An inner space of the frame is opened and closed through rotation of the respective blades. In an open state where the blades are opened, the air can pass through the shutter device. In contrast, in a closed state where the blades are closed, the flow of the air through the frame is blocked.

In recent years, there is a circumstance that an available empty space in the engine room of the vehicle is reduced due to various factors, such as an increase in the number of devices installed in the engine room. Therefore, it is demanded to reduce an installation space for the shutter device of the vehicle. In order to meet such a demand, the inventors of the present application have been considering placement of the shutter device in a narrow space formed between two heat exchangers, such as a radiator and a condenser. In a case where the shutter device is placed at such a location, it is required to reduce a thickness of the shutter device.

Furthermore, in the closed state of the shutter device, a ram pressure is applied to the blades by a traveling wind applied to the vehicle during traveling thereof. In a case where the strength of the frame is reduced by reducing the thickness of the shutter device, the frame is likely to be deformed toward a downstream side in the air flow direction in response to conduction of the force, which is applied to the blades by the ram pressure, to the frame. When the frame is deformed, the frame and/or the blades may possibly contact the heat exchanger located on the rear side of the shutter device to possibly cause damage to the heat exchanger. Furthermore, in a case where the shutter device is vibrated through, for example, transmission of vibrations of the vehicle to the shutter device, the heat exchanger may possibly be damaged through contact of the frame and/or the blades to the heat exchanger located on the front side or the rear side of the shutter device.

According to one aspect of the present disclosure, there is provided a shutter device for a vehicle that has one or more heat exchangers arranged along a flow of air to be applied to the one or more heat exchangers from a grill opening of the vehicle. The shutter device includes a frame, a plurality of blades and a cushion member. The frame is configured to be placed on a front side or a rear side of the one or more heat exchangers along the flow of the air, or is configured to be placed between two heat exchangers in a case where the one or more heat exchangers include the two heat exchangers. The frame has an inner space located at an inside of the frame and is configured to conduct the air through the inner space when the air is introduced from the grill opening. The plurality of blades are located in the inner space of the frame and are rotatably supported by the frame. The plurality of blades are configured to open and close the inner space of the frame through rotation of the plurality of blades. The cushion member is configured to project from the frame toward an adjacent one of the one or more heat exchangers which is placed adjacent to the frame. A direction, in which the cushion member projects from the frame, is defined as a predetermined direction. The cushion member has an elastic property that a repulsive force of the cushion member exponentially changes in response to a change in an amount of shrinkage deformation of the cushion member in the predetermined direction.

Like the above configuration, in the case where the shutter device includes the cushion member, the cushion member may need to be slightly shrunk at the time of installing the shutter device to a location adjacent to the heat exchanger. In such a case where the cushion member configured in the above-described manner is used, as long as the cushion member is only slightly shrunk, the repulsive force of the cushion member does not become excessively large. Therefore, the cushion member can be easily shrunk. Thus, the installation of the shutter device relative to the heat exchanger is eased. Furthermore, when the frame is deformed, the shrinkage deformation amount of the cushion member is increased, and thereby the repulsive force of the cushion member is exponentially increased. Therefore, a repulsive force, which keeps the frame away from the heat exchanger, is applied to the frame. As a result, the frame and the blades are less likely to come into contact with the heat exchanger, and thereby damage to the heat exchanger can be easily avoided.

Hereinafter, embodiments of a shutter device of a vehicle will be described with reference to the drawings. In order to facilitate the understanding, the same reference signs are attached to the same constituent elements in each drawing where possible, and redundant explanations are omitted.

### First Embodiment

First of all, a structure of a vehicle, to which a shutter device of a first embodiment is installed, will be described.

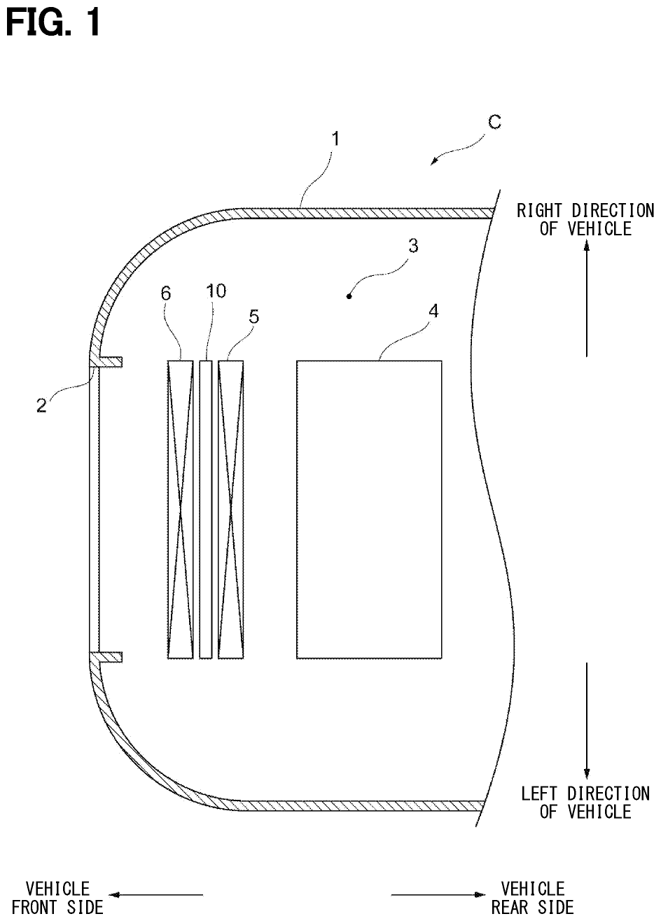

As shown in FIG. 1, a grill opening 2 is formed at a front of a body 1 of a vehicle C. The grill opening 2 is formed to introduce the air from the front side of the body 1 of the vehicle C into an engine room 3. In addition to an engine 4 of the vehicle C, a radiator 5 and a condenser 6 are installed in the engine room 3. The radiator 5 exchanges heat between coolant for cooling the engine 4 and the air introduced from the grill opening 2 to release the heat from the coolant. The condenser 6 is a component of a refrigeration cycle of an air conditioning apparatus installed to the vehicle C. The condenser 6 exchanges heat between the refrigerant circulated in the refrigeration cycle and the air introduced from the grill opening 2 to release heat from the refrigerant. The radiator 5 and the condenser 6 are located between the grill opening 2 and the engine 4. In the present embodiment, the radiator 5 serves as a first heat exchanger, and the condenser 6 serves as a second heat exchanger.

The shutter device 10, which can temporarily block the flow of the air from the grill opening 2 into the engine room 3, is placed between the radiator 5 and the condenser 6 which serve as adjacent heat exchangers, respectively, placed adjacent to the shutter device 10. The shutter device 10 enables early warm-up of the engine 4, for example, by temporarily blocking the flow of the air from the grill opening 2 into the engine room 3 during the time of cold start of the engine 4. Furthermore, the shutter device 10 can improve an aerodynamic performance of the vehicle C by temporarily blocking the flow of the air into the engine room 3, for example, when the vehicle C is traveling at a high speed.

Next, a specific structure of the shutter device 10 will be described.

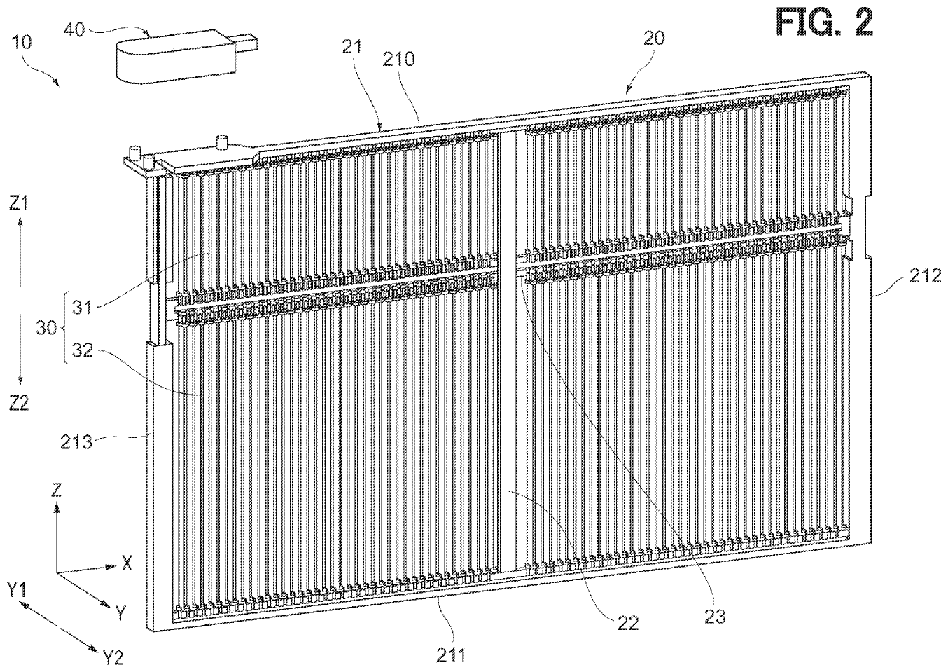

As shown in FIG. 2, the shutter device 10 includes a frame 20, a plurality of blades 30 and an actuator device 40.

The frame 20 includes a first frame main body 21, a second frame main body 22 and a third frame main body 23. The first frame main body 21 is shaped in a rectangular form. The second frame main body 22 and the third frame main body 23 intersect with each other in a crisscross form at the inside of the first frame main body 21.

The first frame main body 21 includes an upper frame piece 210, a lower frame piece 211, a right frame piece 212 and a left frame piece 213. The air, which is introduced from the grill opening 2 shown in FIG. 1, is introduced into the inner space of the first frame main body 21.

Hereinafter, a longitudinal direction of the upper frame piece 210 and the lower frame piece 211 will be also referred to as an X-axis direction (an axial direction along an X-axis), and a longitudinal direction of the right frame piece 212 and the left frame piece 213 will be also referred to as a Z-axis direction (an axial direction along a Z-axis). Furthermore, a Z1 direction, which is one direction along the Z-axis, will be referred to as an upward direction, and a Z2 direction, which is an opposite direction that is opposite to the one direction along the Z-axis, will be referred to as a downward direction. Furthermore, a direction, which is perpendicular to both of the X-axis direction and the Z-axis direction, will be also referred to as a Y-axis direction (an axial direction along a Y-axis). The Y-axis direction corresponds to a flow direction of the air to be applied to the first and second heat exchangers from the grill opening 2, so that the Y-axis direction will be also referred to as an air flow direction Y. Furthermore, one direction, which is along the Y-axis (air flow direction Y) and is directed toward the upstream side with respect to the flow of the air, will be also referred to as an air flow upstream direction Y1, and an opposite direction, which is along the Y-axis (air flow direction Y) and is directed toward the downstream side with respect to the flow of the air, will be also referred to as an air flow downstream direction Y2.

The second frame main body 22 is formed to reinforce the first frame main body 21. The third frame main body 23 is formed to hold the blades 30 and reinforce the first frame main body 21. The second frame main body 22 extends from the upper frame piece 210 to the lower frame piece 211 at the first frame main body 21. The third frame main body 23 extends from the right frame piece 212 to the left frame piece 213 at the first frame main body 21. The inner space of the first frame main body 21 is partitioned into four regions by the second frame main body 22 and the third frame main body 23.

Corresponding ones of the blades 30 are arranged at each of the four regions at the inside of the frame 20. At each of the four regions at the inside of the frame 20, the corresponding ones of the blades 30 are arranged one after another in the X-axis direction such that a longitudinal direction of the respective ones of the blades 30 coincides with the Z-axis direction. In the following description, among the plurality of blades 30 shown in FIG. 2, the corresponding blades 30, which are located between the upper frame piece 210 of the first frame main body 21 and the third frame main body 23, will be referred to as upper blades 31, and the corresponding blades 30, which are located between the lower frame piece 211 and the third frame main body 23, will be referred to as lower blades 32.

Upper end parts of the upper blades 31 are rotatably supported by the upper frame piece 210 of the first frame main body 21, and lower end parts of the upper blades 31 are rotatably supported by the third frame main body 23. Upper end parts of the lower blades 32 are rotatably supported by the third frame main body 23, and lower end parts of the lower blades 32 are rotatably supported by the lower frame piece 211.

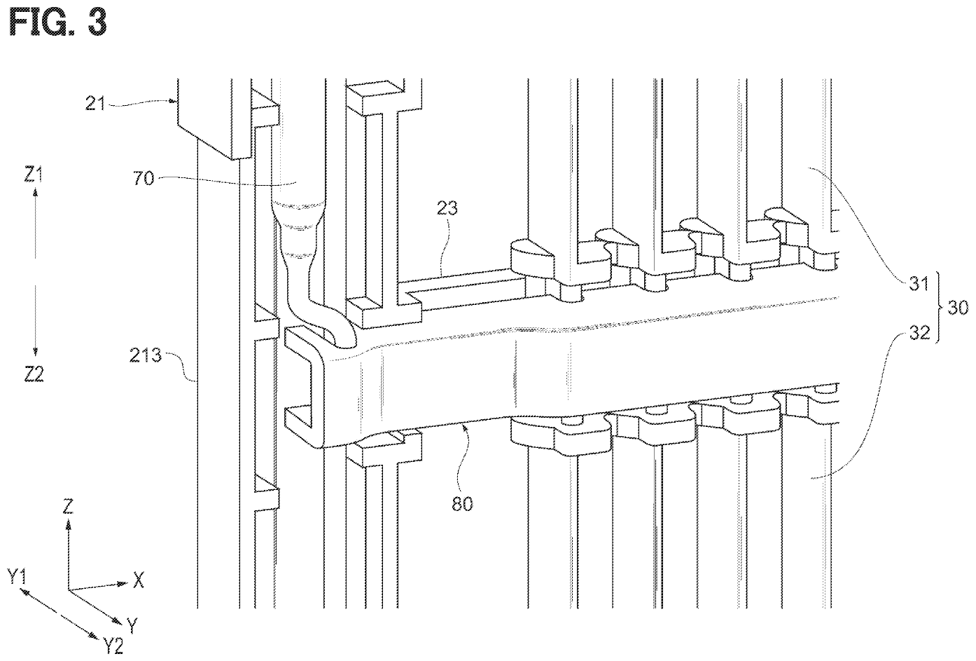

As shown in FIG. 3, a link member 80 is installed to the third frame main body 23. The link member 80 extends in the X-axis direction. The lower end parts of the upper blades 31 and the upper end parts of the lower blades 32 are coupled to the link member 80.

A shaft 70 is placed at the left frame piece 213 of the first frame main body 21 such that the shaft 70 upwardly extends from a connection of the left frame piece 213 which is connected to the third frame main body 23. An upper end part of the shaft 70 is coupled to the actuator device 40 shown in FIG. 2. In FIG. 2, illustration of the link member 80 and the shaft 70 is omitted.

The actuator device 40 is installed on the upper side of one end part of the upper frame piece 210 by, for example, screws. The actuator device 40 rotates the shaft 70 in response to supply of an electric power to the actuator device 40. The link member 80 is moved relative to the third frame main body 23 in the X-axis direction in response to the rotation of the shaft 70, so that a rotational force is applied from the link member 80 to the upper blades 31 and the lower blades 32. Therefore, the upper blades 31 and the lower blades 32 are rotated to open or close the inner space of the first frame main body 21. Specifically, in an open state where the blades 30 are opened, a gap is formed between each adjacent two of the blades 30. Therefore, the air can flow from the grill opening 2 into the engine room 3 through the gaps, each of which is formed between the corresponding adjacent two of the blades 30. In a closed state where the blades 30 are closed, the gap formed between each adjacent two of the blades 30 is closed. Therefore, the flow of the air from the grill opening 2 into the engine room 3 is blocked.

In this type of shutter device 10, when the blades 30 are in the closed state, a ram pressure is applied to the blades 30 by a traveling wind applied to the vehicle C during traveling thereof. A force, which is applied to the blades 30 by the ram pressure, is conducted to the frame 20, and thereby the frame 20 is likely to be deformed in the air flow downstream direction Y2. When the frame 20 is deformed, the frame 20 and/or the blades 30 may possibly contact the radiator 5 located on the rear side (the downstream side) of the shutter device 10 to possibly cause damage to the radiator 5. Further, for example, even in a case where the shutter device 10, the radiator 5 and the condenser 6 are vibrated by vibrations of the vehicle C, when the frame 20 and/or the blades 30 contact the radiator 5 and/or the condenser 6, the radiator 5 and/or the condenser 6 may possibly be damaged.

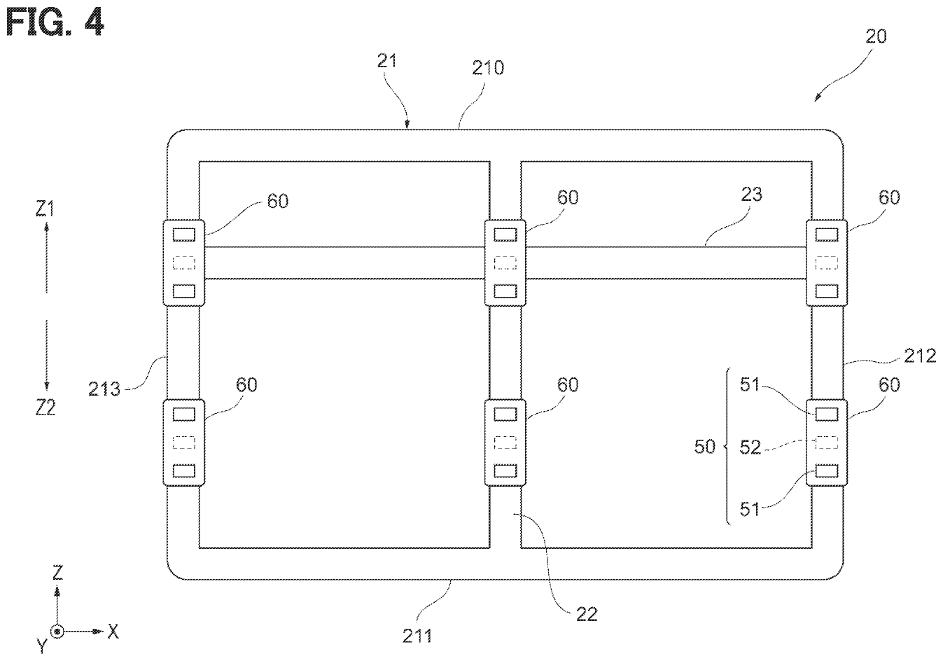

In view of the above point, as shown in FIG. 4, a plurality of cushion members 50, which limit damage to the radiator 5 and damage to the condenser 6, are installed to the frame 20 of the present embodiment. Specifically, an attachment member 60 is installed to an intersection between the right frame piece 212 and the third frame main body 23. Furthermore, another attachment member 60 is installed to the right frame piece 212 at a location between a lower end part of the right frame piece 212 and the intersection between the right frame piece 212 and the third frame main body 23. Attachment members 60 are also installed to the left frame piece 213 and the second frame main body 22 at locations that correspond to the locations of the attachment members 60 attached to the right frame piece 212. Each of the attachment members 60 includes a plurality (two in this instance) of primary cushion members 51, which limit the damage to the radiator 5, and a secondary cushion member 52, which limits damage to the condenser 6. In FIGS. 2 and 3, illustration of the cushion members 50 and the attachment member 60 is omitted.

Next, specific structures of the cushion members 50 and the attachment members 60 will be described.

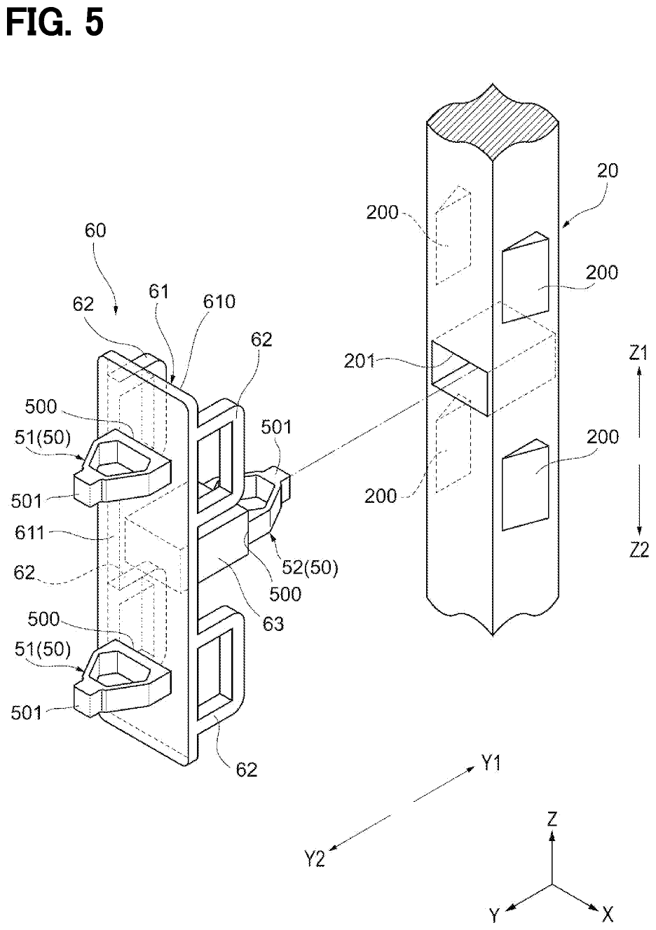

As shown in FIG. 5, each of the attachment members 60 includes a base portion 61, which is shaped in a rectangular plate form, and a plurality (four in this instance) of engaging portions 62, which are formed at two opposed lateral surfaces of the base portion 61. Two of the engaging portions 62 are formed at the two opposed lateral surfaces, respectively, of the base portion 61, which are opposed to each other in the X-axis direction, at an upper half of the base portion 61, and other two of the engaging portions 62 are formed at the two opposed lateral surfaces, respectively, of the base portion 61, which are opposite to each other in the X-axis direction, at a lower half of the base portion 61. Each of the engaging portions 62 is shaped in a rectangular ring form that extends from the base portion 61 in the air flow upstream direction Y1.

A plurality (four in this instance) of claws 200, which are engaged with the four engaging portions 62, respectively, of the corresponding attachment member 60, are formed at two opposed lateral surfaces of the frame 20, which are opposite to each other in the X-axis direction, at each of corresponding portions of the frame 20 which correspond to the attachment members 60, respectively. When the engaging portions 62 of the attachment member 60 are engaged to the claws 200 of the frame 20, the attachment member 60 is fixed to the frame 20.

One of two opposed surfaces of the base portion 61 shown in FIG. 5, which are opposed to each other in a plate thickness direction (the Y-axis direction) of the base portion 61, is a surface 610. The surface 610 is a surface of the base portion 61 that is opposed to the frame 20 when the frame 20 is installed to the attachment member 60. The other one of the two opposed surfaces of the base portion 61, which are opposed to each other in the plate thickness direction of the base portion 61, is a surface 611. The other surface 611 is a surface of the base portion 61 that is opposite to the surface 610 which is opposed to the frame 20 when the frame 20 is installed to the attachment member 60. Hereinafter, the surface 610 will be referred to as a bottom surface 610, and the surface 611 is referred to as a top surface 611.

A projection 63 is formed generally at a center of the bottom surface 610 of the base portion 61 such that the projection 63 projects in the air flow upstream direction Y1. A through hole 201, into which the projection 63 of the attachment member 60 is inserted, is formed at the frame 20. The through hole 201 extends through the frame 20 in the air flow direction Y.

Two of the cushion members 50 are respectively fixed to a generally center of the upper half of the top surface 611 and a generally center of the lower half of the top surface 611 at the base portion 61 of the attachment member 60, and the other cushion member 50 is fixed to a distal end of the projection 63 of the attachment member 60. The cushion members 50, which are installed to the top surface 611 of the base portion 61 of the attachment member 60, are the primary cushion members 51 which limit the damage to the radiator 5. The cushion member 50, which is installed to the distal end of the projection 63 of the attachment member 60, is the secondary cushion member 52 which limits damage to the condenser 6.

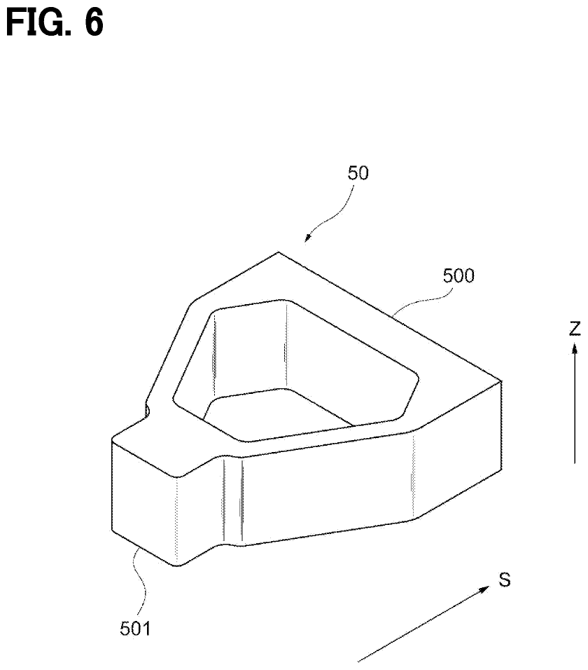

As shown in FIG. 6, the cushion member 50 is a rubber member that has a cross section, which is perpendicular to the Z-axis direction and is shaped in a hollow hexagonal form. In the present embodiment, the Z-axis serves as a predetermined axis of the cushion member 50. One side of the cushion member 50 is defined as a fixation side (fixation surface) 500, and another side of the cushion member 50, which is opposed to the fixation side 500, is defined as a distal end side (distal end surface) 501. The cushion member 50 is shaped in a hollow modified polygonal form where the fixation side 500 is longer than the distal end side 501 in the X-axis direction. The distal end side 501 has a relatively large thickness in the Y-axis direction. When a force is applied to the distal end side 501 in a direction of an arrow S, the cushion member 50 undergoes shrinkage deformation in the direction indicated by the arrow S. The cushion member 50 functions as a cushion by generating a repulsive force, which corresponds to the amount of shrinkage deformation (hereinafter referred to as the shrinkage deformation amount) in the direction of the arrow S.

As shown in FIG. 5, each of the primary cushion members 51 is installed to the attachment member 60 such that the fixation side 500 of the primary cushion member 51 is fixed to the top surface 611 of the base portion 61 of the attachment member 60. The secondary cushion member 52 is installed to the attachment member 60 such that the fixation side 500 of the secondary cushion member 52 is fixed to the distal end surface of the projection 63 of the attachment member 60. The primary cushion members 51 and the secondary cushion member 52 are integrally formed in one-piece with the attachment member 60 by double molding (two-shot molding).

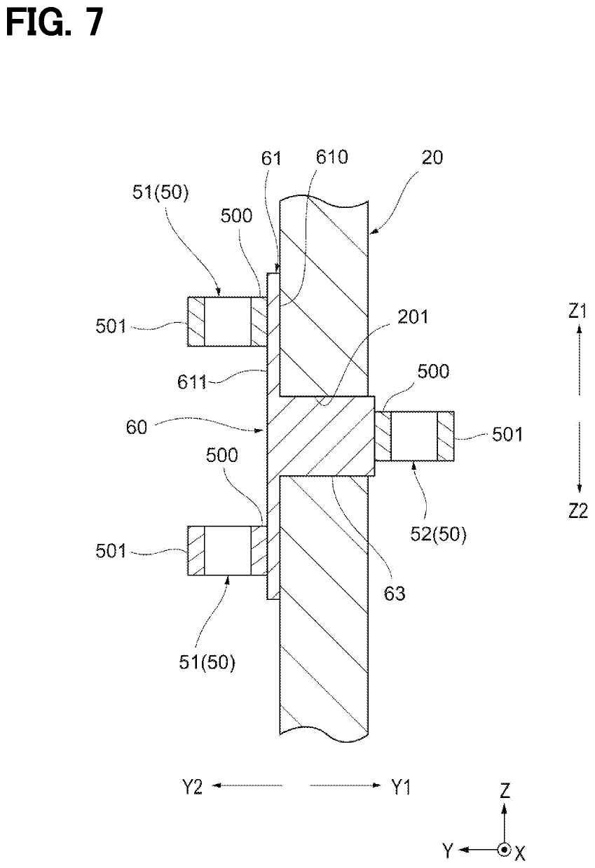

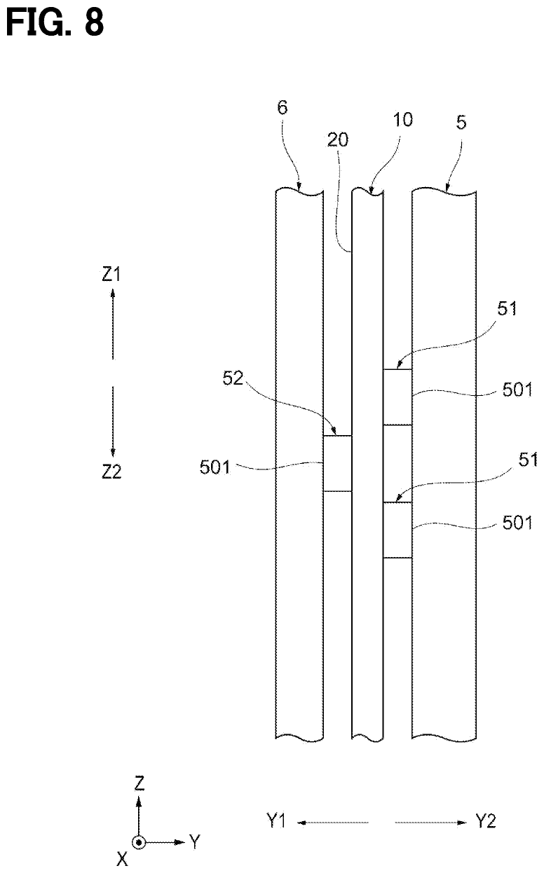

As shown in FIG. 7, the attachment member 60 is installed to the frame 20. When the attachment member 60 is installed to the frame 20 as indicated in FIG. 7, the distal end side 501 of the primary cushion member 51 projects furthermost away from the frame 20 in the air flow downstream direction Y2 at the primary cushion member 51. Furthermore, the distal end side 501 of the secondary cushion member 52 projects furthermost away from the frame 20 in the air flow upstream direction Y1 at the secondary cushion member 52. As shown in FIG. 8, in the state where the shutter device 10 is installed between the radiator 5 and the condenser 6, the distal end sides 501 of the primary cushion members 51 contact the radiator 5, and the distal end side 501 of the secondary cushion member 52 contacts the condenser 6. In the present embodiment, the air flow downstream direction Y2 serves as a predetermined direction of the respective primary cushion members 51, and the air flow upstream direction Y1 serves as a predetermined direction of the secondary cushion member 52.

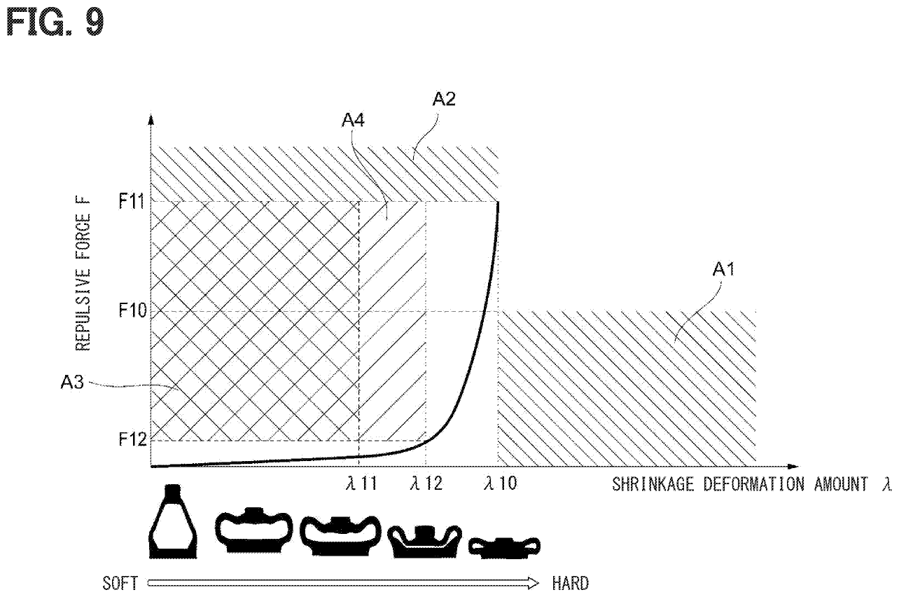

FIG. 9 is a graph showing a relationship between the shrinkage deformation amount λ of the cushion member 50 and the repulsive force F of the cushion member 50 when the cushion member 50 undergoes the shrinkage deformation in the direction of the arrow S in FIG. 6. In the present embodiment, the direction of the arrow S shown in FIG. 6 serves as a predetermined direction of the cushion member 50.

As shown in FIG. 9, the repulsive force F of the cushion member 50 exponentially changes in response to a change in the shrinkage deformation amount λ of the cushion member 50. The characteristic of the repulsive force F relative to the shrinkage deformation amount λ of the cushion member 50 is set to deviate from four regions A1 to A4 shown in FIG. 9. This is due to the following reason.

In a case where the shutter device 10 shown in FIG. 8 is deformed in the air flow downstream direction Y2 by the ram pressure, the primary cushion members 51 undergo the shrinkage deformation. Furthermore, in a case where the shutter device 10 together with the radiator 5 and the condenser 6 are vibrated, the secondary cushion member 52 may also undergo the shrinkage deformation in addition to the primary cushion members 51. At the time of occurrence of the shrinkage deformation of the primary cushion members 51 and/or the secondary cushion member 52, when the shrinkage deformation amount of the cushion member 51, 52 is excessively large or the repulsive force of the cushion member 51, 52 is excessively small, there is a concern that the shutter device 10 contacts the radiator 5 and/or the condenser 6. Hereinafter, this concern will be referred to as a first concern. In order to dispel this first concern, it is demanded to the cushion member 50 that the shrinkage deformation amount is smaller than a predetermined amount λ10, and the repulsive force is equal to or larger than a predetermined value F10 in a case where the shrinkage deformation amount is equal to or larger than the predetermined amount λ10. Specifically, the cushion member 50 is required to have the characteristic that does not satisfy the region A1 shown in FIG. 9, i.e., does not fall in the region A1 shown in FIG. 9.

Furthermore, at the time of occurrence of the deformation of the shutter device 10 shown in FIG. 8 in the air flow downstream direction Y2 by the ram pressure, when the repulsive force of the primary cushion members 51 and the repulsive force of the secondary cushion member 52 are excessively large, there is a concern that the radiator 5 and/or the condenser 6 are damaged. Hereinafter, this concern will be referred to as a second concern. In order to dispel this second concern, it is demanded to the cushion member 50 that the repulsive force of the cushion member 50 is equal to or smaller than a predetermined value F11. Specifically, the cushion member 50 is required to have the characteristic that does not satisfy the region A2 shown in FIG. 9, i.e., does not fall in the region A2 shown in FIG. 9.

Furthermore, in the case where the shutter device 10 shown in FIG. 8 is used, in order to install the shutter device 10 between the radiator 5 and the condenser 6, there is required an assembling operation that the primary cushion members 51 and the secondary cushion member 52 are slightly shrunk and deformed and then the shutter device 10 is moved to the location between the radiator 5 and the condenser 6. Therefore, when the repulsive forces of the primary cushion members 51 and the secondary cushion member 52 are excessively large, there is a concern that the workability at the time of assembling the shutter device 10 is deteriorated. Hereinafter, this concern will be referred to as a third concern. In order to dispel this third concern, it is demanded to the cushion member 50 that the repulsive force of the cushion member 50 is equal to or smaller than a predetermined value F12 in a case where the shrinkage deformation amount of the cushion member 50 is equal to or smaller than a predetermined value λ11. Specifically, the cushion member 50 is required to have the characteristic that does not satisfy the region A3 shown in FIG. 9, i.e., does not fall in the region A3 shown in FIG. 9.

Furthermore, in a case where the shutter device 10 shown in FIG. 8 is deformed in the air flow downstream direction Y2 by the ram pressure, the shutter device 10 is spaced away from the condenser 6, so that the secondary cushion member 52 is deformed in an expanding direction of the secondary cushion member 52. At this time, when the distal end side 501 of the secondary cushion member 52 is moved away from the condenser 6 to form a gap between the distal end side 501 of the secondary cushion member 52 and the condenser 6, there is a concern that a foreign object is clogged in the gap, or corrosive liquid is accumulated in the gap. Furthermore, due to the vibrations of the shutter device 10 and the condenser 6, after the formation of the gap between the distal end side 501 of the secondary cushion member 52 and the condenser 6, the tip end side 501 of the secondary cushion member 52 and the condenser 6 may contact with each other once again. When this phenomenon is repeated, there is a concern that an impact force is applied from the secondary cushion member 52 to the condenser 6. Hereinafter, this concern will be referred to as a fourth concern. This fourth concern may cause damage to the condenser 6. In order to dispel this third concern, it is sufficient that the distal end side 501 of the secondary cushion member 52 maintains its contact to the condenser 6 even when the secondary cushion member 52 is expanded due to the deformation of the shutter device 10 in the air flow direction Y. In order to satisfy this need, the shrinkage deformation amount of the secondary cushion member 52 may be set to be equal to or larger than a predetermined value λ12 in the state where the shutter device 10 is placed between the radiator 5 and the condenser 6. Furthermore, in view of the workability at the time of assembling the shutter device 10, it is desirable that the repulsive force of the secondary cushion member 52 at the time of shrinking the secondary cushion member 52 by the predetermined value λ12 is equal to or smaller than a predetermined value F12. Requirements, which are similar to the above requirements, exist for the primary cushion members 51. As described above, each cushion member 50 is required to have the characteristic that does not satisfy the region A4 shown in FIG. 9, i.e., does not fall in the region A4 shown in FIG. 9.

As shown in FIG. 9, the characteristic of the repulsive force F with respect to the shrinkage deformation amount λ of the cushion member 50 is set so as to deviate from the four regions A1 to A4 shown in FIG. 9. This makes it possible to dispel the above-mentioned first to fourth concerns.

According to the shutter device 10 of the present embodiment described above, actions and advantages recited in the following sections (1) to (6) can be achieved.

(1) Each of the cushion members 50 is arranged such that the cushion member 50 projects from the frame 20 toward the corresponding one of the radiator 5 and the condenser 6. Each of the cushion members 50 has the elastic property that the repulsive force F of the cushion member 50 exponentially changes in response to a change in the shrinkage deformation amount λ of the cushion member 50 in the direction indicated by the arrow S in FIG. 6. According to this configuration, as long as the cushion member 50 is only slightly shrunk, the repulsive force of the cushion member 50 does not become excessively large. Therefore, the cushion member 50 can be easily shrunk. Therefore, the shutter device 10 can be easily installed between the radiator 5 and the condenser 6. On the other hand, when the frame 20 is deformed, the shrinkage deformation amount of the cushion member 50 is increased, and thereby the repulsive force of the cushion member 50 is exponentially increased. Therefore, the repulsive force, which keeps the frame 20 away from the radiator 5 and the condenser 6, is applied to the frame 20. As a result, the frame 20 and the blades 30 are less likely to come into contact with the radiator 5 and the condenser 6, so that the damage to the radiator 5 and the damage to the condenser 6 can be easily avoided.

(2) Each of the primary cushion members 51 is arranged such that the primary cushion member 51 contacts the radiator 5. Furthermore, each of the secondary cushion members 52 is arranged such that the secondary cushion member 52 contacts the condenser 6. According to this configuration, it becomes difficult to form a gap between the primary cushion member 51 and the radiator 5 or between the secondary cushion member 52 and the condenser 6. Therefore, it is possible to dispel the concern, such as the intrusion of the foreign object into such a gap.

(3) Each of the cushion members 50 is the member that has the cross section which is perpendicular to the Z-axis direction and is shaped in the hollow modified polygonal form such that the width of the distal end side 501 of the cushion member 50 is smaller than the width of the fixation side 500 of the cushion member 50. According to this configuration, it is easy to realize the cushion member 50 having the characteristic, such as the characteristic shown in FIG. 9.

(4) Each of the cushion members 50 is integrally formed in one-piece with the attachment member 60 by the double molding. The cushion member 50 is indirectly fixed to the frame 20 by installing the attachment member 60 to the frame 20. According to this configuration, the cushion member 50 can be retrofitted to the frame 20 by simply installing the attachment member 60 to the frame 20.

(5) The attachment member 60 is provided with the primary cushion members 51, each of which projects from the frame 20 to the radiator 5, and the secondary cushion member 52, which projects from the frame 20 to the condenser 6, as the cushion members 50. According to this configuration, even when the shutter device 10 is installed between the radiator 5 and the condenser 6, the radiator 5 and the shutter device 10 are less likely to come into contact with each other, and the condenser 6 and the shutter device 10 are less likely to come into contact with each other.

(6) Each of the attachment members 60 is assembled to the frame 20 in the direction that is parallel to the air flow direction Y. According to this configuration, the attachment members 60 can be easily installed to the frame 20.

### (First Modification)

Next, a first modification of the shutter device 10 of the first embodiment will be described.

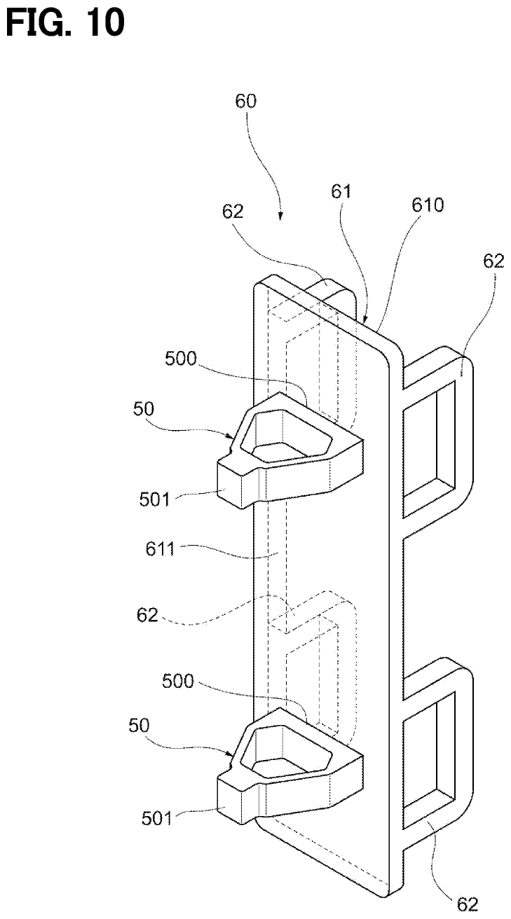

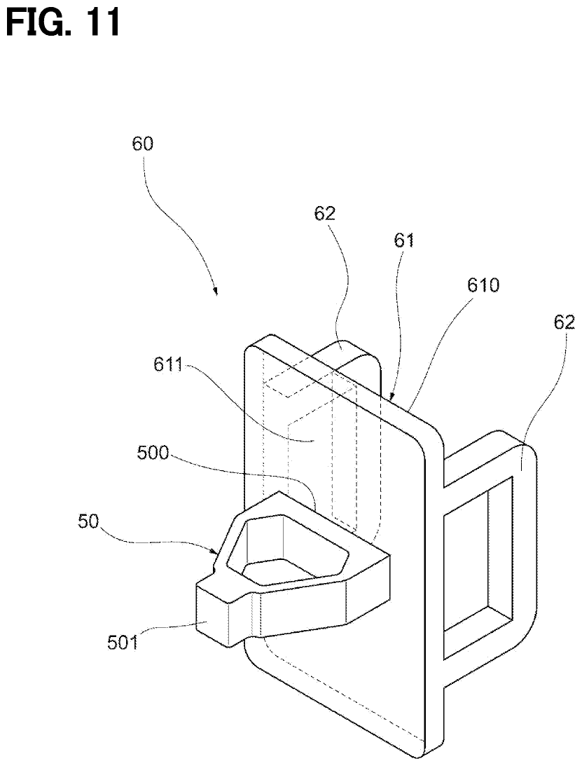

Since the shutter device 10 is easily deformed by the influence of the traveling wind of the vehicle, there is a high possibility that the shutter device 10 will be deformed toward the radiator 5 located in the air flow downstream direction Y2 of the air flow with respect to the shutter device 10. Therefore, each of the attachment members 60 may have only the cushion members 50 which correspond to the radiator 5. For example, as indicated in FIG. 10, each of the attachment members 60 may be an attachment member 60 that has the plurality of cushion members 50 only at the top surface 611 that is opposed to the radiator 5. Furthermore, each of the attachment members 60 is not necessarily limited to the attachment member 60 of FIG. 10 having the plurality of cushion members 50 but may be, for example, an attachment member 60 that has a single cushion member 50 as shown in FIG. 11.

### (Second Modification)

Next, a second modification of the shutter device 10 of the first embodiment will be described.

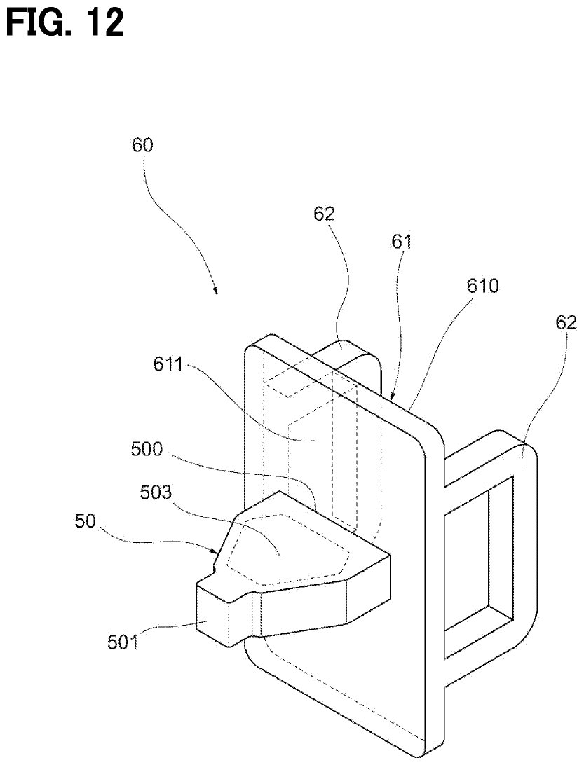

In the case of the cushion member 50 shown in FIG. 11, when a foreign object enters the hollow portion of the cushion member 50, the elastic property shown in FIG. 9 may not be obtained. Therefore, as shown in FIG. 12, a cushion member 50 of the present modification is provided with a closure 503 that closes an upper opening of the hollow portion of the cushion member 50. As a result, the foreign object, which falls downward from an upper side of the cushion member 50, will not enter the hollow portion of the cushion member 50, and thereby the elastic property of the cushion member 50 can be easily ensured.

The closure 503 may be formed not only at the upper opening of the hollow portion of the cushion member 50 but also at the lower opening of the hollow portion of the cushion member 50.

### (Third Modification)

Next, a third modification of the shutter device 10 of the first embodiment will be described.

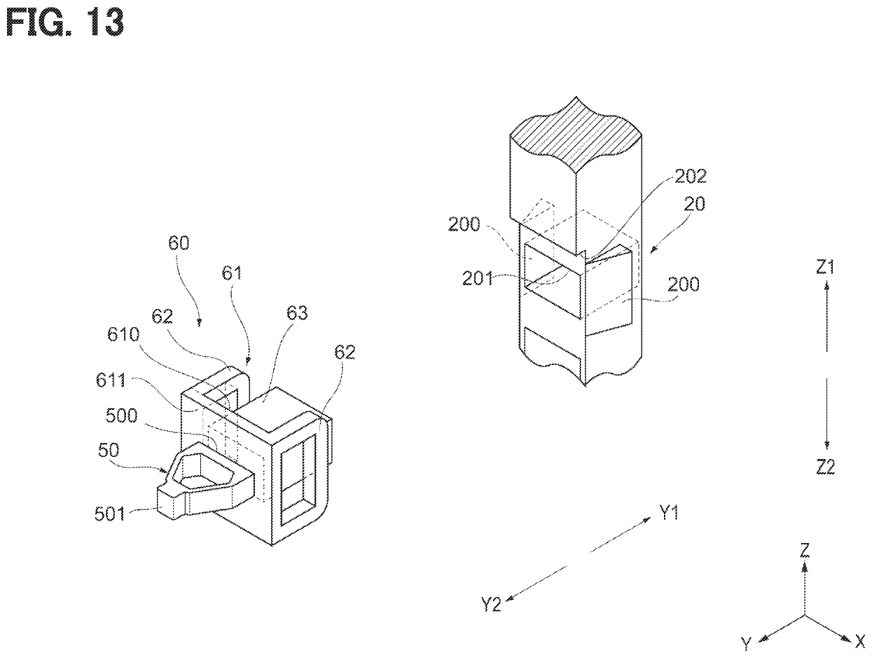

As shown in FIG. 13, a groove 202 is formed at a portion of the frame 20 of this modification where the attachment member 60 is installed. This makes it possible to insert the base portion 61 of the attachment member 60 into the groove 202 when the attachment member 60 is assembled to the frame 20.

### (Fourth Modification)

Next, a fourth modification of the shutter device 10 of the first embodiment will be described.

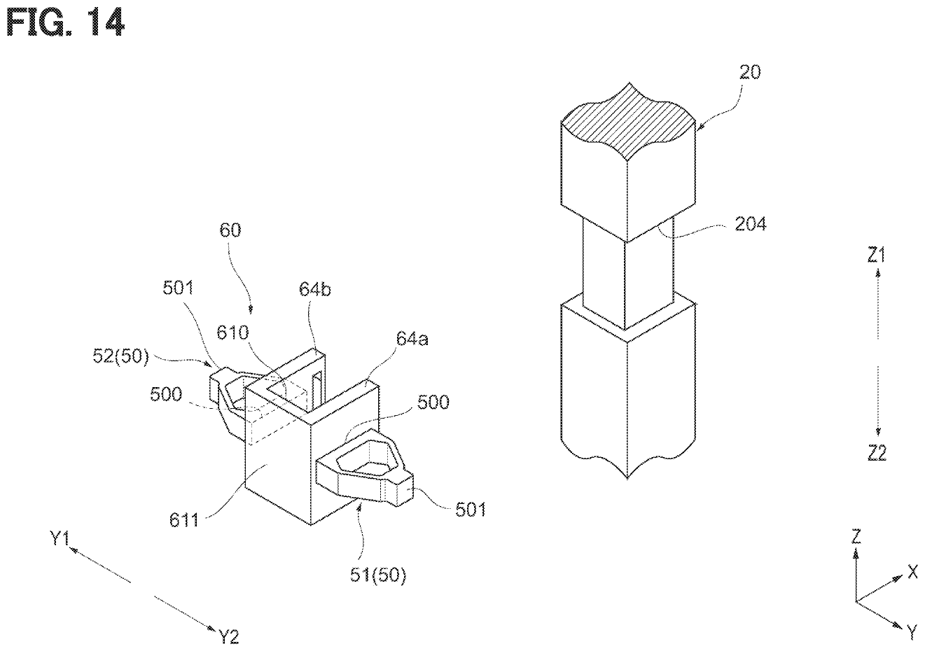

As shown in FIG. 14, the attachment member 60 of this modification is formed such that a cross section of the attachment member 60, which is perpendicular to the Z-axis direction, is shaped in a U-form. The attachment member 60 is assembled to an installation portion 204 of the frame 20 in the X-axis direction. In other words, the attachment member 60 is assembled to the frame 20 in the direction that is perpendicular to the air flow direction Y. When the frame 20 is assembled to the attachment member 60, two side walls 64a, 64b of the attachment member 60, which are opposed to each other, are opposed to the radiator 5 and the condenser 6, respectively. The cushion member 50 is placed at an outer surface of each of the side walls 64a, 64b. The cushion member 50, which is located at the side wall 64a opposed to the radiator 5, serves as the primary cushion member 51, and the cushion member 50, which is located at the side wall 64b opposed to the condenser 6, serves as the secondary cushion member 52.

Even in the case where the attachment member 60 and the cushion members 50 shown in FIG. 14 are used, actions and advantages, which are the same or similar to those of the shutter device 10 of the first embodiment, can be achieved.

### Second Embodiment

Next, a shutter device 10 of a second embodiment will be described. In the following, the second embodiment will be described mainly with respect to differences relative to the shutter device 10 of the first embodiment.

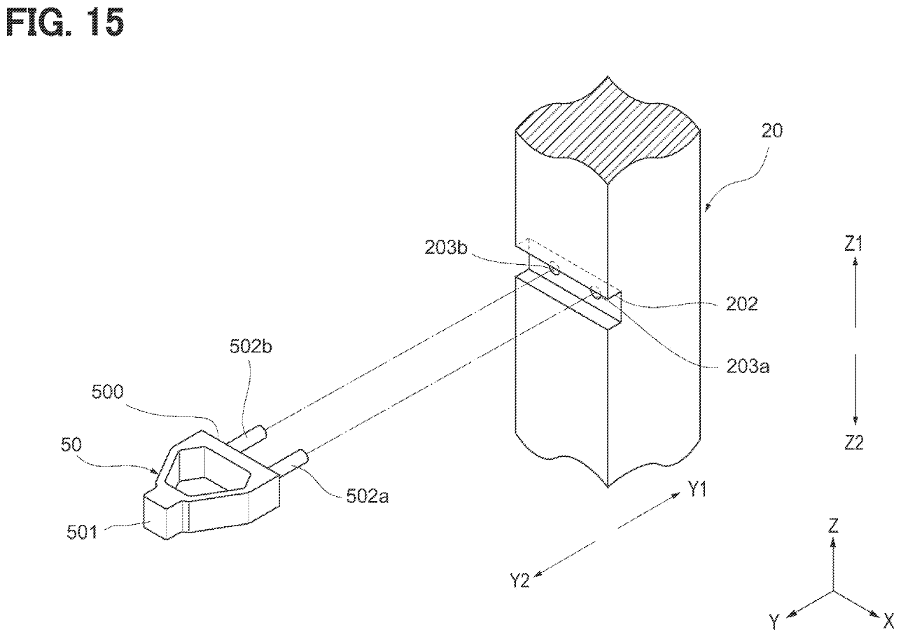

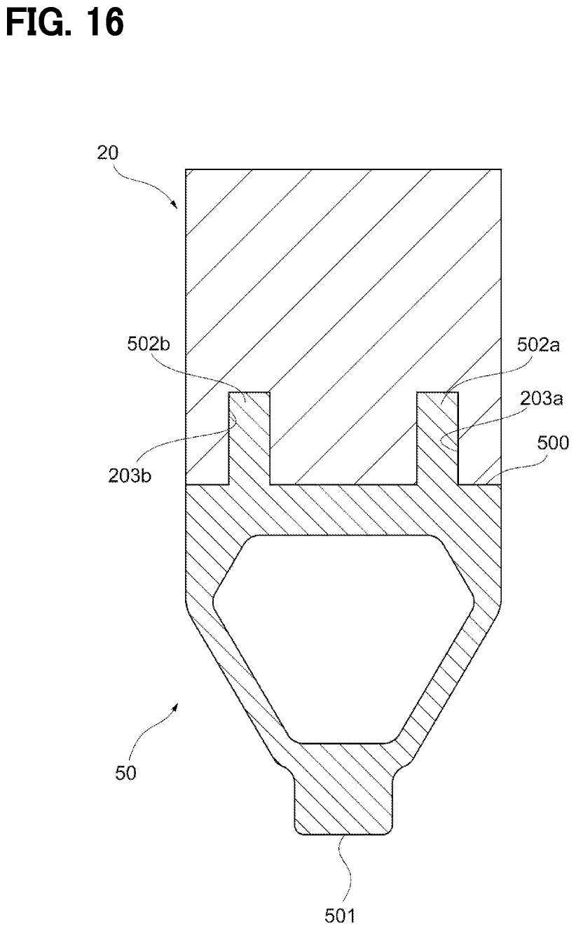

As shown in FIGS. 15 and 16, the shutter device 10 of the present embodiment has a structure in which each of the cushion members 50 is directly assembled to an outer surface of the frame 20 which is opposed to the radiator 5. Specifically, a plurality (two in this instance) of projections 502a, 502b are formed at a bottom surface of the fixation side 500 of the cushion member 50. The frame 20 has a groove 202 into which the fixation side 500 of the cushion member 50 is inserted. A plurality (two in this instance) of insertion holes 203a, 203b, into which the projections 502a, 502b of the cushion member 50 are inserted, are formed at a bottom surface of the groove 202. The fixation side 500 of the cushion member 50 is inserted into the groove 202 of the frame 20, and the projections 502a, 502b of the cushion member 50 are inserted into the insertion holes 203a, 203b of the frame 20. Therefore, the cushion member 50 is fixed to the frame 20. With this configuration, the cushion member 50 is directly assembled to the frame 20.

Here, it should be noted that the cushion member 50 may be additionally provided to another outer surface of the frame 20, which is opposed to the condenser 6, besides the cushion member 50 provided to the outer surface of the frame 20 which is opposed to the radiator 5.

The shutter device 10 of the present embodiment described above can provide an action and an advantage recited in the following section (7) besides the actions and advantages recited in the above sections (1) to (3).

(7) The cushion member 50 is formed separately from the frame 20 and is directly fixed to the frame 20. With this configuration, since the attachment member 60 of the first embodiment is not required, the number of the components can be reduced.

### Other Embodiments

The present disclosure may be implemented as follows.

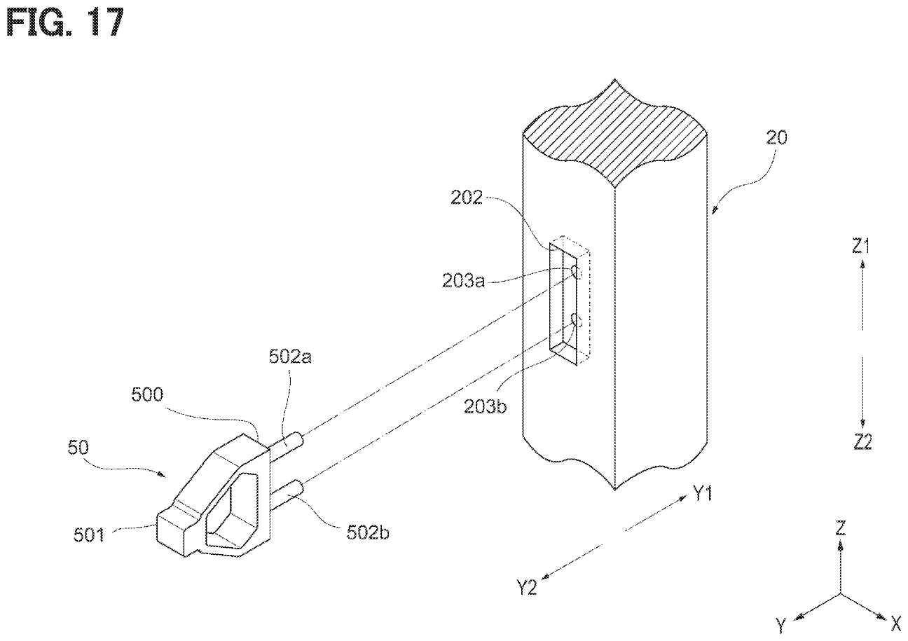

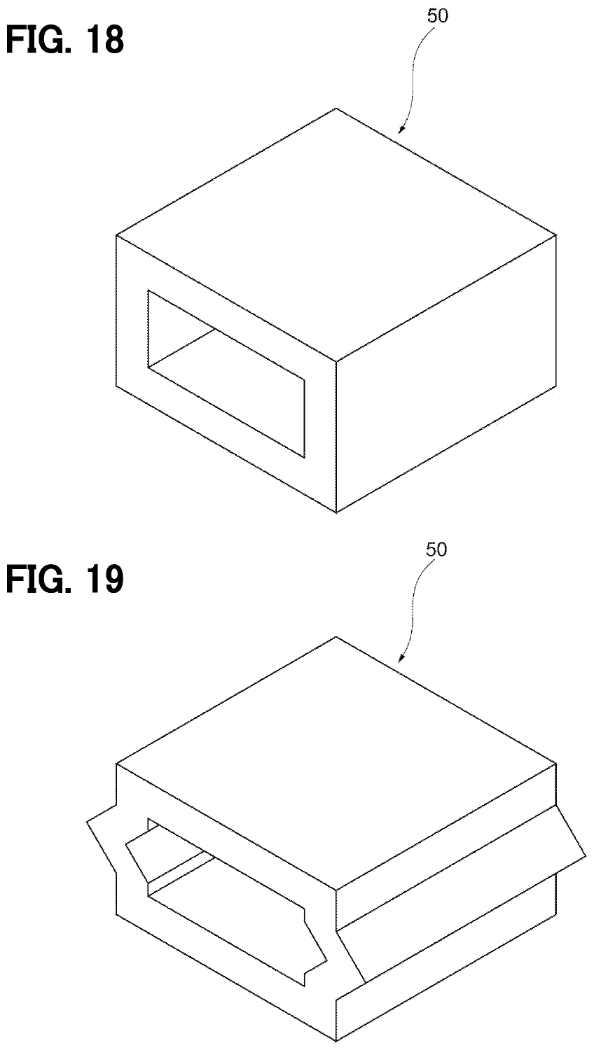

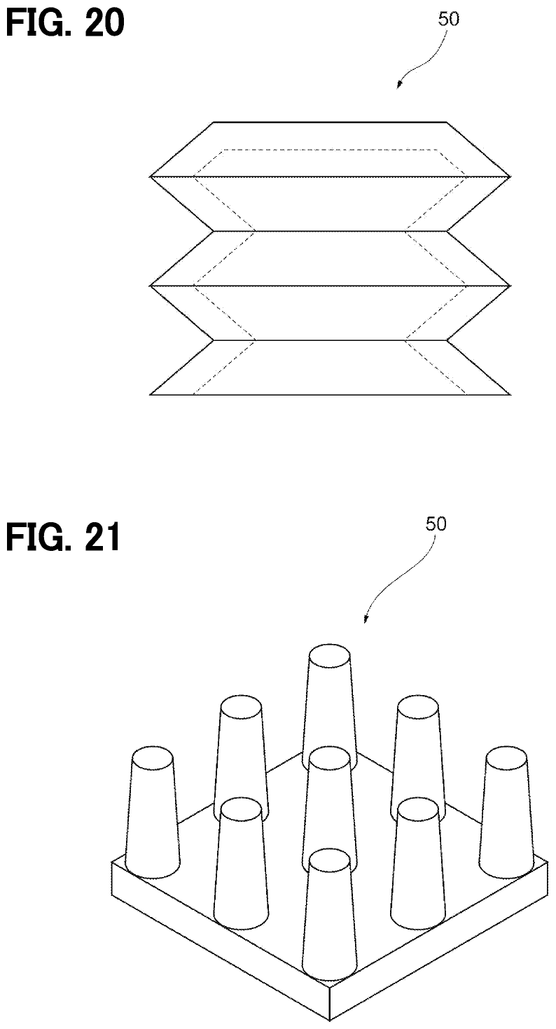

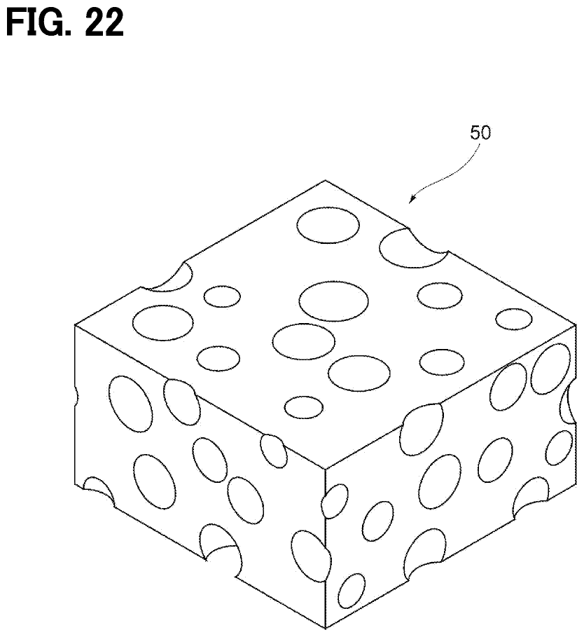

The shape of the cushion member 50 may be appropriately changed. The cushion member 50 is not necessarily limited to the cushion member 50 having the hollow portion that opens in the Z-axis direction as shown in FIG. 15. For example, the cushion member 50 may be rotated by 90 degrees about a central axis of the cushion member 50, which is parallel to the Y-axis direction, from the orientation of the cushion member 50 shown in FIG. 15 to implement an orientation of the cushion member 50 shown in FIG. 17, and thereby the cushion member 50 has a hollow portion that opens in the X-axis direction. Furthermore, the cushion member 50 may be shaped in a hollow form shown in FIG. 18 or FIG. 19, a bellows-like hollow form shown in FIG. 20, or a form having a plurality of projections shown in FIG. 21. Furthermore, as the cushion member 50, it is also possible to use a porous foam rubber as shown in FIG. 22. Alternatively, the cushion member 50 may be a cushion member that has a cross section which is perpendicular to a predetermined axis thereof and is shaped in a hollow polygonal form, such as a hollow trapezoidal form. Furthermore, as long as the characteristic shown in FIG. 9 is satisfied, the cushion member 50 may be a solid elastic body.

The cushion member 50 may be integrally formed in one-piece with the frame 20 by double molding.

The shutter device 10 of each of the above embodiments is not necessarily limited to the shutter device 10 installed between the radiator 5 and the condenser 6. For example, the shutter device 10 may be a shutter device installed between any two heat exchangers. For instance, in a case where an intake air cooler, which cools the intake air of the internal combustion engine of the vehicle, and the condenser are arranged in the air flow direction Y, the shutter device may be placed between the intake air cooler and the condenser. Furthermore, the shutter device 10 may be placed on a front side (the upstream side along the flow of the air from the grill opening 2) or a rear side (the downstream side along the flow of the air from the grill opening 2) of one or more heat exchangers arranged along the flow of the air to be applied to the one or more heat exchangers from the grill opening 2 of the vehicle. For instance, in FIG. 1, the shutter device 10 may be placed on the front side (the upstream side) of the condenser 6 at a location adjacent to the condenser 6, or may be placed on the rear side (the downstream side) of the radiator 5 at a location adjacent to the radiator 5. Furthermore, in a case where the vehicle has the intake air cooler discussed above, the condenser 6 and the radiator 5 as the heat exchangers, the shutter device 10 may be placed on the front side (the upstream side) or the rear side (the downstream side) of these three heat exchangers.

The present disclosure should not be limited to the specific examples described above. The examples described above may be appropriately modified by a person skilled in the art in various ways, and these modifications should be included within the scope of the present disclosure as long as the modifications have the characteristic feature of the present disclosure. Each element included in each of the above-mentioned specific examples, and its arrangement, its condition, its shape and the like are not limited to those illustrated and may be appropriately changed. The combinations of the elements of the respective examples described above may be appropriately changed as long as there is no technical contradiction.

1. A shutter device for a vehicle having one or more heat exchangers arranged along a flow of air to be applied to the one or more heat exchangers from a grill opening of the vehicle, the shutter device comprising:
a frame that is configured to be placed on a front side or a rear side of the one or more heat exchangers along the flow of the air, or is configured to be placed between two heat exchangers in a case where the one or more heat exchangers include the two heat exchangers, wherein the frame has an inner space located at an inside of the frame and is configured to conduct the air through the inner space when the air is introduced from the grill opening;
a plurality of blades that are located in the inner space of the frame and are rotatably supported by the frame, wherein the plurality of blades are configured to open and close the inner space of the frame through rotation of the plurality of blades; and
a cushion member that is configured to project from the frame toward an adjacent one of the one or more heat exchangers which is placed adjacent to the frame, wherein:
a direction, in which the cushion member projects from the frame, is defined as a predetermined direction; and
the cushion member has an elastic property that a repulsive force of the cushion member exponentially changes in response to a change in an amount of shrinkage deformation of the cushion member in the predetermined direction.

2. The shutter device according to claim 1, wherein the cushion member is arranged to contact the adjacent one of the one or more heat exchangers.

3. The shutter device according to claim 1, wherein the cushion member is hollow.

4. The shutter device according to claim 3, wherein:
the cushion member has a cross section, which is perpendicular to a predetermined axis of the cushion member and is shaped in a hollow polygonal form, and one side of the cushion member is directly or indirectly fixed to the frame;
the one side of the cushion member, which is directly or indirectly fixed to the frame, is defined as a fixation side, and another side of the cushion member, which projects furthermost away from the frame in the predetermined direction at the cushion member, is defined as a distal end side; and
a width of the distal end side is smaller than a width of the fixation side.

5. The shutter device according to claim 4, wherein the cross section of the cushion member, which is perpendicular to the predetermined axis, is shaped in a hollow modified polygonal form such that the width of the distal end side is smaller than the width of the fixation side.

6. The shutter device according to claim 4, wherein the cushion member has a closure which closes an opening of a hollow portion of the cushion member.

7. The shutter device according to claim 1, wherein the cushion member is formed separately from the frame and is directly fixed to the frame.

8. The shutter device according to claim 1, further comprising an attachment member that is integrally formed in one-piece with the cushion member by double molding, wherein the attachment member is installed to the frame to indirectly fix the cushion member to the frame.

9. The shutter device according to claim 8, wherein:
the frame is configured to be placed between the two heat exchangers;
one of the two heat exchangers is a first heat exchanger, and another one of the two heat exchangers is a second heat exchanger; and
the cushion member is one of a plurality of cushion members that include a primary cushion member, which projects from the frame toward the first heat exchanger, and a secondary cushion member, which projects from the frame toward the second heat exchanger, while the primary cushion member and the secondary cushion member are integrally formed in one-piece with the attachment member by the double molding.

10. The shutter device according to claim 8, wherein the attachment member is assembled to the frame in a direction that is parallel to a flow direction of the air.

11. The shutter device according to claim 8, wherein the attachment member is assembled to the frame in a direction that is perpendicular to a flow direction of the air.

12. The shutter device according to claim 1, wherein the cushion member is integrally formed in one-piece with the frame by double molding.
